(19) United States
(12) Patent Application Publication
(10) Pub. No.: US 2026/0170688 A1
(43) Pub. Date: Jun. 18, 2026

(54) METHOD FOR DETERMINING AT LEAST ONE CAMERA PARAMETER FOR CALIBRATING A CAMERA, AND A CAMERA

(71) Applicant: Robert Bosch GmbH, Stuttgart (DE)

(72) Inventors: Michael Seiter, Hildesheim (DE); Andreas Wellhausen, Elze (DE); Emil Schreiber, Hannover (DE); Florian Richter, Lamspringe (DE); Gregor Blott, Salzgitter (DE); Matthias Kirschner, Hildesheim (DE); Moritz Michael Knorr, Hildesheim (DE); Nils Zerrer, Eindhoven (NL); Sven Wagner, Ihlow (DE)

(21) Appl. No.: 18/880,917

(22) PCT Filed: Jun. 12, 2023
(86) PCT No.: PCT/EP2023/065657

§ 371 Date: Jan. 3, 2025

(30) Foreign Application Priority Data
Jul. 5, 2022 (DE) 10 2022 206 860.0

(51) Int. Cl. G06T 7/80; G06T 7/73

(52) U.S. Cl. CPC G06T 7/80; G06T 7/73; G06T 2207/20081; G06T 2207/30236

(57) ABSTRACT

The invention relates to a method for determining at least one camera parameter for calibrating a camera, in particular a traffic monitoring camera, having the steps of: providing one or more images (200) of the surroundings, said images being captured by mean of the camera, determining coordinates of at least two respective corner points (231-234) on an image plane (y′, z′) for a 3D bounding box (230) of one or all of a plurality of objects (220, 250, 252), in particular vehicles, in the one or more images (200); and determining the at least one camera parameter on the basis of at least one distance (241-243) on the image plane, said distance being defined by the coordinates of the at least two corner points (231-234) of the respective 3D bounding box (230), and at least one corresponding specified distance in a surroundings coordinate system; and providing the at least one camera parameter.

### BACKGROUND

The present invention relates to a method for determining at least one camera parameter for calibrating a camera, as well as a computing unit, a camera and a computer program for carrying out the same.

Cameras can be used to monitor surroundings such as highways, buildings, fences, or offices. So-called intelligent cameras or camera systems are increasingly being used for this purpose. Calibration of the camera is usually required for them to function properly. Options for calibrating cameras, for example, are known from EP 2 044 573 B1, EP 2 798 611 B1 and US 2019/0311494 A1.

### SUMMARY

According to the invention, a method is proposed for determining at least one camera parameter for calibrating a camera, as well as a computing unit, a camera and a computer program for carrying out the same with the features of the independent patent claims. Advantageous embodiments are the subject of the dependent claims and the following description.

The invention relates to cameras, in particular traffic monitoring cameras, as well as in particular their calibration or the determination of one or more camera parameters for calibrating such a camera, i.e. camera parameters, on the basis of which the geometrical imaging behavior of the camera is described. A calibration may include both extrinsic and intrinsic calibration. Extrinsic camera parameters are e.g., roll angle, pitch angle, and camera height (above the ground), intrinsic camera parameters are e.g., a focal length, or also main point and distortion.

Such camera parameters may be obtained, for example, on the basis of information determined and provided manually. For example, dimensions of objects in images captured by means of the camera may be manually specified and provided so that calibration may be performed. However, this is very complex and often not practical, especially in complicated surroundings to be monitored.

In the context of the present invention, a procedure is now proposed, which in particular allows automatic calibration of the camera. For this purpose, one or more images of the surroundings, e.g., a highway, captured by means of the camera (to be calibrated) are provided or obtained, e.g., in a computing unit performing these tasks. In the preferred case of multiple images, this may be, for example, individual frames of a video, as well as separately captured images.

For a 3D bounding box of one or all of a plurality of objects in the one or more images, coordinates of at least two corner points are then determined in a camera coordinate system. The objects considered here are vehicles in particular, but people or trailers can also be considered, for example.

A 3D bounding box is a cuboid into which the object is fitted, i.e., an enveloping cuboid. However, this 3D bounding box is then projected onto the image or camera plane or the plane of the camera sensor, i.e. into the image. A projected 3D bounding box (as used here in particular) is thus defined by eight corner points, each having coordinates on the image plane (image coordinates). By projecting the 3D bounding box onto the camera plane, each corner point has two degrees of freedom, e.g., an x coordinate and a y coordinate.

For the proposed method, however, not all eight corner points or their coordinates are necessary, but two corner points may be sufficient. However it is also expedient when the coordinates of at least three, in particular at least four, further in particular up to eight corner points for the 3D bounding box of one or all of the plurality of objects are determined.

It is particularly preferred if determining the coordinates of the at least two corner points is performed by means of a machine learning algorithm, in particular an artificial neural network (e.g., a Deep Neural Network, DNN), which obtains the one or more images as input data.

The machine learning algorithm then predicts (or estimates) a certain number of corner points (or generally keypoints) for each of the objects in the image, for example. Either individual images (i.e., the plurality of images individually) may be used as input data for the machine learning algorithm, or an image series comprising a plurality of contiguous or even time-separated images that are simultaneously processed as a batch. The architecture of a DNN can vary and be, for example, an anchor-based approach or an anchor-free approach, or work on the basis of a ‘convolutional neural network’ or on the basis of a ‘transformer network’ (such as a Swin transformer). For example, as a predictive result of the DNN, all eight corner points of the enveloping cuboid (projected 3D bounding box) of the object projected onto the camera plane may then be used. In this case, the DNN would have a full 16 degrees of freedom (each of the eight projected corner points has an x and y coordinate). Alternatively, a subset of the eight corner points may be predicted (determined), e.g., only four corner points, from which the remaining four corner points result from the linear combination of the predicated four corner points. In the latter case, the system has eight degrees of freedom.

Such a machine learning algorithm or neural network may be obtained, e.g., by training, by providing the projected 3D bounding boxes and/or the corner points of interest or all corner points of the projected 3D bounding boxes to the objects as training data for a plurality of images with objects. In this respect, it is noted that the 3D bounding boxes and projected 3D bounding boxes themselves do not necessarily need to be fully determined, rather the coordinates of the corner points of interest are sufficient. If, for example, the optics of the camera produce a distorting image, i.e., lines in the world/camera system are mapped onto curves, the eight corner points and not the curves are still of interest here.

Furthermore, the at least one camera parameter is then determined on the basis of at least one distance in the image plane (i.e., in an image coordinate system that is typically 2D), defined on the basis of the coordinates of the at least two corner points of the respective projected 3D bounding box, and at least one corresponding specified distance in the surroundings coordinate system or camera coordinate system. The at least one camera parameter is then provided. For example, the specified distance is a width of a vehicle and/or a length of a vehicle and/or a height of a vehicle and/or a size of a vehicle that can be determined therefrom, for example a length of a diagonal of a vehicle.

As mentioned, a 3D bounding box is a cuboid that envelops an object like a vehicle. Accordingly, certain distances are defined by the corner points, namely the distances between two corner pointes, in particular the edges of the cuboid. Examples of such distances defined by the corner points include, for example, a length, a width, and a height. For such distances, there are corresponding distances in the surroundings coordinate system (i.e., the real surroundings), e.g., the length, a width, and a height of the real object, e.g., the vehicle. A real width or length of a vehicle is known for different types of vehicles, for example.

The at least one camera parameter may then be determined because the distance between two corner points in the camera coordinate system must correspond to the corresponding real distance; this, for example, requires certain values for the extrinsic camera parameters such as pitch angle, roll angle, and height.

It is particularly expedient if the at least one camera parameter is determined on the basis of distances for multiple 3D bounding boxes, or in other words, on the basis of the at least one distance defined by the coordinates of the at least two corner points of multiple 3D bounding boxes. This may comprise multiple images, each with one or more objects, wherein each object is assigned a 3D bounding box. The more distances (or objects and images) are used, the more precisely the at least one camera parameter can be determined, e.g., as part of an optimization method.

If distances between several (projected) 3D bounding boxes (on the image plane) are determined, in the simplest case one and the same dimensions, i.e. distances between the corner points or keypoints, of the 3D bounding boxes can be assumed, e.g., that all vehicles in the surroundings coordinate system have the same width. For example, if the average width is assumed for the width of vehicles, then the deviations between the actual width of individual vehicles and the average width are averaged statistically (e.g., assuming the law of large figures), so that an exact result is achieved for a sufficiently large number of detected vehicles. As part of an optimization method, for example, different distances in the 3D bounding boxes are then balanced out.

Preferably, at least one object parameter is also determined from the one or all of the plurality of objects in the one or more images. The position in the plane and orientation (rotation about the vertical axis) of the objects are considered as object parameters, for example. To determine the at least one camera parameter, the at least one camera parameter and the at least one object parameter are then optimized as part of an optimization method.

The disparaged procedure or calibration makes particular use of the fact that the axes resulting from the corner points 3D of the bounding boxes are perpendicular to each other. By assuming at least one length (or e.g., length and width), a hypothesis for the extrinsic properties of the camera can thus already be created from a single vehicle observation. The extrinsic properties are in particular described by the three parameters roll angle, pitch angle, and height above ground (or ground, in particular the road) and are therefore different for each plane in the scene or surroundings. Here, it can first be assumed that there is only one plane in the scene. In addition to the three extrinsic parameters, three object parameters can also be used for each object or vehicle. The position in the plane (two parameters) and the rotation or rotation about the vertical axis or plane normal, so that a top view can be created at any given time. All object and vehicle observations (or the four ground corner points of each 3D bounding box) can serve as a measurement here. In an optimization method, for example, the extrinsic parameters and object parameters are then estimated or optimized simultaneously, for example, wherein a rear projection error is minimized. More specifically, the four ground corners of the 3D bounding box are projected into the image assuming an average vehicle size and the extrinsic camera parameters and object parameters and compared with the detected corner points.

If, for example, average values are always assumed for the object or vehicle size, it is expedient to use only cars (passenger vehicles). This can be achieved, for example, by the machine learning algorithm mentioned above only considering cars as objects. It should be noted that the estimated parameters are correct if the observed vehicles (or general objects) have the assumed average sizes (distances) on average.

In a preferred embodiment, observations (i.e., images and the coordinates and parameters obtained therefrom), are not immediately discarded, so that more and more object parameters have to be estimated. A fixed, i.e. constant, number of vehicle observations (objects) can also always be used.

Observations or objects can be discarded according to different schemes. For example, the age of the observation may be considered. For example, older observations may be discarded to permit a continuous re-estimation of the parameters. Generally, for example, the plurality of images that are taken into account may include only current images that are determined according to a specified criterion, for example, only images from the last ten minutes or the last 100 images. This is critical, for example, if the orientation of the camera or the mounting (of the camera) can change over time (e.g., due to thermal influences).

Likewise, for example, the cover in the image may be considered. For the calibration, it is advantageous if measurements or observations (i.e. objects present in the image) are available in the entire relevant area of the detected surroundings. This applied in particular if an uncurved plane (on which the objects are located, e.g., a flat roadway) is assumed, but the actual roadway is slightly curved (e.g., due to a slope). In this case, the average plane estimate is often desired.

Likewise, for example, different vehicles or generally different objects, i.e. types of objects, can be considered. As the size of vehicles, for example, may deviate from the assumed average values, different vehicles/observations should be used wherever possible. This can be ensured, e.g., by tracking vehicles on the basis of the generated top plan view. In addition, different vehicle (or person) classes may be used if they have an average size. In this case, for example, there is not only a specified distance overall, but one per vehicle class (e.g., cars and trucks).

In addition to the extrinsic camera parameters, a focal length (e.g., expressed by the opening angle) may also be determined (or estimated) as an intrinsic parameter. For example, perspective effects of the individual 3D bounding boxes can be considered, e.g., the position of the escape points resulting from the connections of the corner points.

In general, further intrinsic parameters (e.g., main point, distortion) can be estimated. As each single projected 3D bounding box (particularly assuming at least four corner points that are not on one plane) already allows the determination of the extrinsic parameters (angle and height), the intrinsic parameters can be determined from the observation of several vehicles and world assumptions, such as a common basic plane, as in this case, the same extrinsic calibration parameters must be determined for all vehicles. A (systematic) deviation can therefore be used to determine (calibrate) the intrinsic parameters.

In particular, four corner points on the ground of the 3D bounding box were taken as a basis and an average length and width dimension was assumed. However, in general only a single dimension (distance), e.g., only width or height, is required. At the same time, the four upper corner points can also be used. These are located in a plane parallel to the road. Preferably, there should be at least three (connected) corner points and two lengths or four points and a length. However, it is also possible to add observations without reference to length, e.g., for vehicles that have a higher variance in length/width/height, such as vans or commercial vehicles. Only the perpendicularity of the legs is utilized.

In the foregoing explanations, a (main) plane (the roadway) was assumed. However, it is generally also possible to assume multiple planes or curved surfaces. Parametric surfaces (e.g., described by polynomials) may be used for curved surfaces. At the same time, each image may also be broken down into grid cells, for example, and the at least one camera parameter (in particular an extrinsic calibration) may be determined for each grid cell. Neighborhood properties between grid cells may also be utilized (e.g., smoothing, for example via a Markov random field). For these approaches, the above-described approach may be altered so that each object or vehicle generates a hypothesis. These would then be locally clustered and corresponding parameters would be derived per cluster. Thus, for each cluster or grid cell, there is a separate, different extrinsic calibration (with corresponding calibration parameters). These can then be utilized in various ways, e.g., by interpolation with polynomials, such as a changing surface (change in height and orientation).

One property that is utilized in the proposed method is the perpendicularity of the 3D bounding boxes as well as their position on the ground (a vehicle is on the roadway). In general, 3D bounding boxes can therefore also be used for people, trailers or other objects, not just vehicles.

A preferred extension of the approach presented herein is the calibration via time tracking of objects. Even if there is no assumed length reference, it can be utilized that the dimensions of an object do not change over time. For example, object dimensions can be determined on the basis of the currently assumed calibration and the camera parameters. These may then be used in later images. In particular, this may be incorporated into a holistic process or estimator, wherein the object dimensions are estimated, but are assumed to be constant over time.

A further application or extension is, for example, an automatic, simultaneous construction of maps that contain, for example, lane information. Simple methods (e.g., grid-based) may be used for this on the basis of the generated top plan view.

In summary, simple and versatile 3D bounding box corner point detectors are used for fully automatic calibration of (in particular stationary) cameras. In particular, the projections of 3D bounding box coordinates into the image are used to infer an extrinsic as well as (in extension) intrinsic calibration. Advantages are in particular the direct estimation of the corner points of the enveloping cuboid (as keypoints) as opposed to estimation of e.g., specific, prominent keypoints on vehicles (e.g., tires, license plates or lights). Thus, no adjustment to specific types of vehicles (possibly beyond a class of trucks/cars/vans) is necessary and extrapolation to other types of vehicles is easier. In addition, fewer length references (only at least one distance must be known) are required than with for other approaches. Classes with high variability can even be used without a length reference.

The approach generally allows estimation of extrinsic properties with respect to multiple planes or even curved surfaces and curves. The number of predicted corner points required (eight in a 3D bounding box) can be further reduced to three or even two. These can all be located on the ground, for example. A particular feature is also the proposed possibility of a one-stage detector (as opposed to multi-stage methods).

A computing unit according to the invention, e.g., a processor of a camera, is configured, in particular in terms of programming, to carry out a method according to the invention.

A camera according to the invention, in particular a traffic monitoring camera, comprises a computing unit according to the invention. It should be mentioned, however, that a computing unit can also be provided separately from the camera, e.g., by outsourcing the method onto a server as a computing unit (e.g., in the so-called cloud).

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

### BRIEF DESCRIPTION OF THE DRAWINGS

Further advantages and embodiments of the invention will emerge from the description and the accompanying drawing.

The invention is illustrated schematically in the drawing on the basis of an exemplary embodiment and is described in the following with reference to said drawing.

FIG. 1 schematically shows the surroundings with a camera to illustrate an embodiment.

FIG. 2 shows an image of the surroundings to illustrate another embodiment.

FIG. 3 schematically shows a sequence of an embodiment.

FIG. 4 shows camera parameters in diagrams, which can be determined in the context of one embodiment.

### DETAILED DESCRIPTION

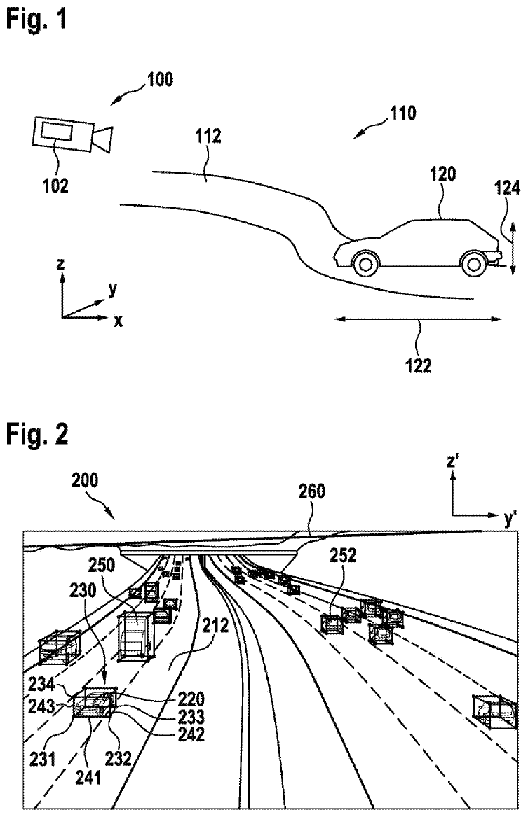

FIG. 1 schematically shows the surroundings 110 with camera 100 to illustrate an embodiment of the invention. A roadway 112 is shown in the environment 110, on which an object 120 formed as a vehicle is located as an example. The camera 100 comprises a computing unit 102 and is used, for example, as a traffic monitoring camera, i.e., it is intended to observe or monitor the surroundings 100 and objects present or appearing therein, in particular vehicles such as the vehicle 120. Calibration of the camera 100 may in particular be necessary for this purpose.

By way of example, the vehicle 120 has a length 122 and a height 124 defined in an ambient coordinate system x, y, z. A width of the vehicle 120 is not shown herein.

In FIG. 2, an image 200 of the surroundings is shown to illustrate a further embodiment of the invention. The image 200 may be an image of the surroundings with objects, in particular vehicles, captured by means of a camera, such as the camera 100 of FIG. 1.

For example, a roadway 212 can be seen in the image 200, as can a plurality of vehicles as objects. By way of example, a vehicle approaching the camera used to capture the image 200 is designated 220, in this case a car, and another vehicle approaching the camera is designated 250, in this case a truck. Also, by way of example, a vehicle traveling away from the camera is designated 252, in this case a car.

With reference to vehicle 200, a so-called 3D bounding box 230 will now be explained, as used in the context of the present invention. The 3D bounding box 230 is a cuboid that envelops the vehicle 220 (or generally an object). The 3D bounding box or cuboid thus comprises eight corner points or is defined by these corner points. For example, four of these corner points are designated 231, 232, 233, and 234. Two of the corner points are connected to each other by lines or edges (there are a total of 12 edges for a cuboid), wherein three edges are designated 241, 242, and 243 as examples. These edges are now perpendicular to each other at the corner points, and the cuboid or 3D bounding box rests on a plane defined by the roadway 212.

As the 3D bounding box 230 envelopes the vehicle 220, the lengths of certain edges correspond to corresponding maximum dimensions of the vehicle 220 Thus, the length of the edge 241 (the distance between the corner points 231 and 232) corresponds to the width of the vehicle 220, the length of the edge 242 (the distance between the corner points 232 and 233) corresponds to the length of the vehicle 220 (see also length 122 in FIG. 1), and the length of the edge 243 (the distance between the corner points 231 and 234) corresponds to the height of the vehicle 220 (see also height 124 in FIG. 1).

By projecting the 3D bounding box 230, the corner points have coordinates on the image plane y′, z′, i.e., a 2D coordinate system on the camera plane or the sensor plane. Accordingly, these coordinates are in 2D, i.e., two-dimensional, while the 3D bounding box 230 itself is three-dimensional. Thus the 3D bounding box 230 is projected onto the 2D plane.

Likewise, for the further vehicles, 3D bounding boxes can be defined with corner points, as shown in FIG. 2. 3D bounding boxes can also be defined for other objects such as people or trailers. In addition, at 260, an estimated horizon is shown. The position of the horizon in the image is shown here for ease of understanding, as it is easy to determine whether such a horizon is plausible. However, the position and shape of the horizon curve is also directly dependent on the estimated angles of the ground plane as well as the intrinsic camera parameters.

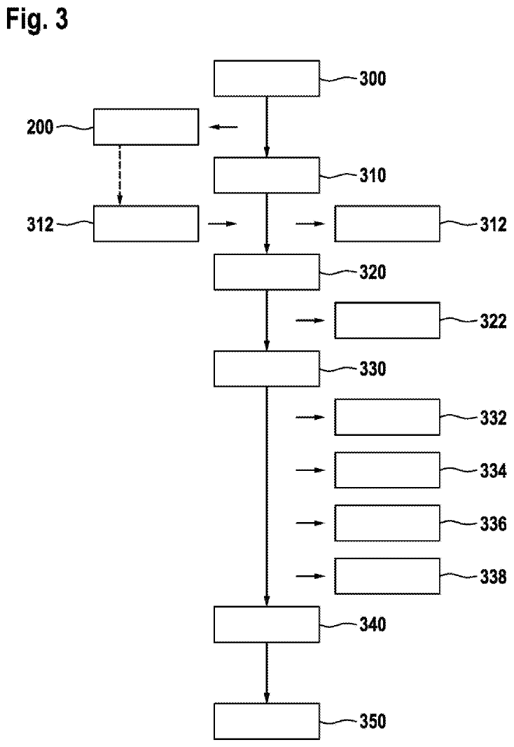

FIG. 3 schematically shows a process of a method in one embodiment, which is to be explained in more detail below, in particular with reference to FIG. 2.

In a step 300, initially one, but preferably several images, such as the image 200, are provided. For this purpose, the images can be captured with the camera.

In a step 310, for example, the coordinates 312 of corner points of a respective projected 3D bounding box are then determined, for each of the objects such as the vehicle 230 in image 200, namely on the image plane y′, z′. For example, an artificial neural network 314 (or other machine learning algorithm) may be used to obtain the images 200 as input data. As already mentioned, the coordinates of all eight corner points of each 3D bounding box can be determined, for example, but also two or three corner points (e.g., 231, 232, 233) are sufficient. The corner pointes or their coordinates also define the distances between the corner points, e.g., the edges 241, 242.

Optionally, in a step 320, object parameters 322 of the vehicles can also be determined, e.g., their position on the roadway 212 as well as their orientation or rotation about a perpendicular to the roadway 212.

In a step 330, e.g., one, but preferably several camera parameters are then determined, e.g., the extrinsic camera parameters roll angle 332, pitch angle 334, and height of the camera above the ground (roadway) 336, and an intrinsic camera parameter 338, e.g., the focal length. This is achieved on the basis of the distances between corner points (in the camera coordinate system x′, y′) as well as at least one corresponding specified distance, such as the length, height or width of a vehicle (in the surroundings coordinate system x, y, z). This can in particular also be achieved as part of an optimization process. Likewise, as part of this optimization process, the aforementioned object parameters 322 can be optimized.

In a step 340, the camera parameters obtained as part of this calibration are then provided. They can then be applied as needed, step 350, to adjust the camera settings.

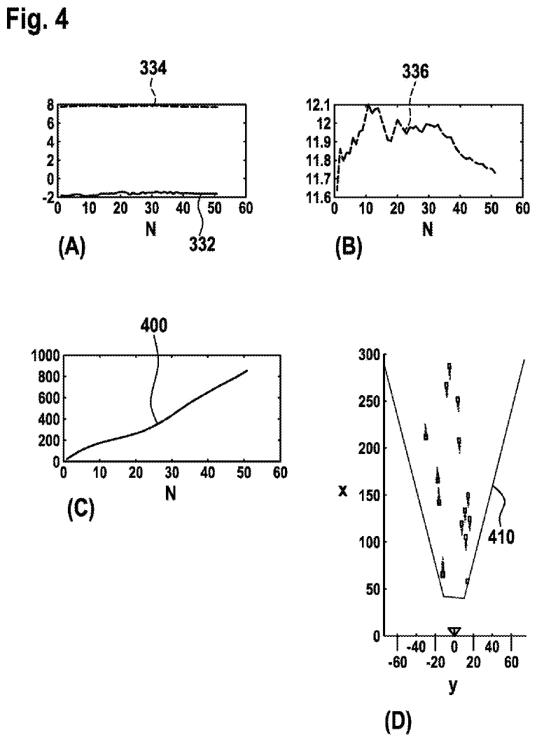

+In FIG. 4, the camera parameters roll angle 332 (upper line) and pitch angle 332 (lower line), each for example in degrees, in diagram (A), height 336, for example in meters, in diagram (B) and number 400 of detected objects in diagram (C), are plotted in diagrams over a number N of processed images or measurements. It can be assumed that the estimation or determination of the camera parameters becomes more accurate with an increasing number of images or measurements,.

Diagram (D) also shows a plan view or top view of the surroundings in the surroundings coordinate system (x, y), wherein vehicles or objects, i.e. their positions and orientations (object parameters) are shown in a field of view 410 of the camera (which is located at x=0, y=0). These object parameters and thus such a view can be obtained, as mentioned, e.g., as part of the optimization. Maps of the lanes, for example, can be determined by repeatedly determined top views as a vehicle typically does not frequently change lanes.

1. A method for determining at least one camera parameter (332, 334, 336, 338) for calibrating a camera (100), the method comprising the steps of:
providing (300) one or more images (200) of the surrounding environment (110), said images being captured by means of the camera (100),
determining (310) coordinates (312) of at least two corner points (231-234) on an image plane (y′, z′) for a 3D bounding box (230) of one or all of a plurality of objects (220, 250, 252) in the one or more images (200),
determining (330) the at least one camera parameter (332, 334, 336, 338) based on at least one distance (241-243) on the image plane, said distance being defined by the coordinates (312) of the at least two corner points (231-234) of the respective 3D bounding box (230), and at least one corresponding specified distance (122, 144) in a surroundings coordinate system, and
providing the at least one camera parameter (332, 334, 336, 338).

2. The method according to claim 1, wherein the coordinates of at least three corner points for the 3D bounding box (230) of one or all of the plurality of objects are determined.

3. The method according to claim 1, wherein the at least one camera parameter (332, 334, 336, 338) is determined on the basis of the at least one distance (241-243) defined by the coordinates (312) of the at least two corner points (231-234) of a plurality of 3D bounding boxes (230), and as part of an optimization method,
wherein a corresponding specified distance in the surroundings coordinate system is used for the distances for the plurality of 3D bounding boxes, for a mean value of the distances of the plurality of 3D bounding boxes.

4. The method according to claim 1, comprising the following steps:
determining (320) at least one object parameter (322) of the one or all of the plurality of objects (220, 250, 252), in the one or more images (200),
wherein the at least one camera parameter (332, 334, 336, 338) and the at least one object parameter (322) are simultaneously optimized as part of an optimization method to determine (330) the at least one camera parameter (332, 334, 336, 338).

5. The method of claim 1, wherein the at least one camera parameter (332, 334, 336, 338) is determined on the basis of a plurality of images, wherein the plurality of images comprises only recent images determined according to a specified criterion.

6. The method according to claim 1, wherein at least one camera parameter is determined for different objects.

7. The method according to claim 1, wherein determining the coordinates of the at least two corner points (231-234) is performed by means of a machine learning algorithm, which obtains the one or more images as input data.

8. The method according to claim 1, wherein the at least one camera parameter (332, 334, 336, 338) comprises at least one extrinsic camera parameter selected from the group consisting of: roll angle, pitch angle, and camera height, and/or wherein the at least one camera parameter comprises at least one intrinsic camera parameter.

9. A computing unit (102) configured to perform all method steps of a method according to claim 1.

10. A traffic monitoring camera, having a computing unit (102) according to claim 9.

11. (canceled)

12. A non-transitory, computer-readable storage medium comprising instructions that when executed by a computer cause the computer to determine at least one camera parameter (332, 334, 336, 338) for calibrating a camera (100), by:
providing (300) one or more images (200) of the surrounding environment (110), said images being captured by means of the camera (100),
determining (310) coordinates (312) of at least two corner points (231-234) on an image plane (y′, z′) for a 3D bounding box (230) of one or all of a plurality of objects (220, 250, 252) in the one or more images (200),
determining (330) the at least one camera parameter (332, 334, 336, 338) based on at least one distance (241-243) on the image plane, said distance being defined by the coordinates (312) of the at least two corner points (231-234) of the respective 3D bounding box (230), and at least one corresponding specified distance (122, 144) in a surroundings coordinate system, and
providing the at least one camera parameter (332, 334, 336, 338).
